(19) United States
(12) Patent Application Publication
(10) Pub. No.: US 2014/0136357 A1
(43) Pub. Date: May 15, 2014

(54) Method for mitigating financial risks associated with participating in an auction

(71) Applicants: Robert Jehle, Overland Park, KS (US); Ryan Jehle, Overland Park, KS (US)

(72) Inventors: Robert Jehle, Overland Park, KS (US); Ryan Jehle, Overland Park, KS (US)

(21) Appl. No.: 14/078,522

(22) Filed: Nov. 12, 2013

Related U.S. Application Data
(60) Provisional application No. 61/724,557, filed on Nov. 9, 2012.

(51) Int. Cl. G06Q 30/08

(52) U.S. Cl. CPC G06Q 30/08
USPC 705/26.3

(57) ABSTRACT

A method for mitigating financial risks associated with participating in an auction in which an auctioneer uses an online platform to auction a commodity to auction participants' remote terminals in communication with the platform via a communication network by charging the participants participation fees that aggregate to an amount which is at least equal to a predetermined percentage of the auctioneer's cost of acquiring the commodity.

This non-provisional application claims the benefit of provisional application No. 61/724,557 filed Nov. 9, 2012.

### BACKGROUND OF THE INVENTION

For much of recorded history, the auction has been a method that people have used to buy and sell goods and services. Generally speaking, an auction is a process involving two or three distinct parties: (a) an auction host that provides the physical or virtual forum in which the auction is held (hereinafter, broadly referred to as an “auctioneer”); (b) a seller that has some/all right of ownership associated with the commodity to be auctioned; and (c) multiple participants that compete against each other to win the right to purchase the commodity from the seller at a price determined by that competition. However, sometimes the auctioneer and seller are one in the same, as the auctioneer may be in the business of obtaining ownership of goods or rights to services merely for the purpose of subsequently selling those goods and services, via auction, and receiving proceeds in excess of the costs of acquiring the commodities. In the discussion that follows, it is assumed that auctioneer and seller are, indeed, the same entity in the sense that it is assumed that the auctioneer pays a significant cost to acquire a good or service that it auctions and that the auctioneer is, thus, under financial pressure to at least recover that acquisition cost, if not also earn a profit, as a result of its hosted auction.

In any event, an auction provides a mechanism for enabling a seller to sell its commodity for fair market value (or for receiving a windfall in view of fair market value), rather than selling it for an arbitrarily set retail price that may actually be less than what a hypothetical buyer might be willing to pay for the commodity. So, from a seller's perspective, the auction provides a way to attempt to maximize the value of its commodity. That is particularly true today, as auctions have become digitized and are conducted on-line in a way that constructively enables anyone with Internet access to become aware that a particular commodity for sale and to effectively express what it would be willing to pay for it. In that sense, the modern auction may provide the truest, most non-speculative way of determining the fair market value of a product. And when conducted online, the market in question can be geographically borderless.

Of course, the term “auction” is a generic term for the proposition of selling commodities in a competitive purchase bid environment. In fact, when “auction” is used in the modern American context, it typically refers to a type of event that is known, more specifically, as an “English auction”—that is, an open auction which is ascending (i.e., each made bid must be higher than the previously made one) and where the auction winner is obligated to pay its winning bid amount in exchange for the auctioned commodity. However, there are other types of auctions that are commonly recognized, today, including the Dutch auction, Japanese auction, Vickrey auction, sealed bid auction, and bidding fee (or “penny”) auction.

In recent years, the penny auction has become especially popular. The salient characteristics of a penny auction are that participants are required to pay to the auctioneer a non-refundable fee for bids which are often offered for sale to participants in a variety of multiple bid packs. During the auction, a countdown (to zero) clock runs. Whenever it reaches zero time remaining, the auction is ended. However, each time a bid is placed prior thereto, the countdown clock is reset to a predetermined time value. In addition, each time a bid is placed, the bid price (i.e., the purchase price) of the auctioned commodity is increased by a small incremental amount—typically, by $0.01. Whenever the clock eventually winds all the way down due to no bidding activity, the last bidder wins the auction and pays (typically, by way of automatic charge to a credit/debit card or deduction from a cash account that the auctioneer has authority to draw against) the outstanding bid price.

This auction method is popular amongst auction participants because it creates potential for them to obtain auctioned items for considerably less than their retail values. It can also be a quite lucrative sales method for an auctioneer in that the auctioneer can realize revenue from the sale of bids to all participants as well as from the commodity sale to the winning participant. Sometimes, bid competition will drive a penny auction bid price even above the retail price of the commodity causing the auctioneer to achieve a considerable windfall, considering the monies also collected from the sale of bids used (many unsuccessfully) in that auction. And even when the winning hid price winds up being far less than the retail value of the auctioned product, the auctioneer often earn some measure of profit, considering the cost of acquiring the commodity, due to the sale of all the bids made on an auctioned product. However, such is not always the case; where bidding activity is light, auctioneers can end up realizing less from the combination of used bids and winning bid price than the amount previously expended to obtain the product in the first place. Furthermore, the penny auction can be a very dissatisfying experience for non-winning participants due to the fact that they essentially waste money spent on the bids that they placed in the auction unsuccessfully.

Consequently, there is an outstanding need fur an auction method in which simultaneously: (a) enables an auctioneer to eliminate, or at least reduce to an acceptable level, its risk of loss (i.e., the risk of realizing an auction revenue amount less than the cost of acquiring the auctioned commodity); and (b) enables auction participants to actively and aggressively participate in the auction at a known, limited non-refundable cost to them (aside from the actual winning bid price paid by the winning participant). The present method substantially fulfills this need.

### SUMMARY OF THE INVENTION

This invention generally relates to methods for facilitating the sale of goods, and it specifically relates to a method for limiting the financial risk normally associated with obtaining commodities to be later sold in an auction of some type, while also limiting the financial risk of those who unsuccessfully attempt to purchase commodities via an auction. Accordingly, while the present method has applicability to multiple types of auctions and for any type of commodity, it has particular applicability to auctions in which higher priced products, like automobiles, boats, homes, etc., are attempted to be sold. Moreover, the current methodology can be used by auctioneers to even determine if they should acquire a commodity for the purpose of, then, auctioning it.

The primary objective of the present invention is to ensure that an online auctioneer recovers at least some minimally acceptable (to them) cash amount prior to initiating an auction and, thereby, subjecting themselves to the possibility of ultimately selling an auctioned item for less than was their cost of acquiring the item. Typically, that acceptable amount will be some predetermined percentage the auctioneer's out-of-pocket cost of obtaining the item. Moreover, typically, an auctioneer will determine this acceptable amount after obtaining the item, but prior to initiating its auction. However, the present method practiced prior to the auctioneer even purchasing the item or otherwise making a financial commitment to obtain ownership or possession rights to it so that it could be auctioned by the auctioneer. This allows an auctioneer to determine whether it can host a profitable auction on an item even before spending funds to acquire it.

Where the auction to be conducted is a bidding fee type auction (e.g., a penny auction, a secondary objective of the present invention is to ensure that interested auction participants are able to identify, prior to the start of bidding, the amount of money that they will spend participating in the auction in the event that they do not win the auction and are unable to obtain the auctioned item.

Thus, it is an object of the present invention to provide a method that prevents an auctioneer for realizing a net loss as result of auctioning a commodity that cost more than the total funds received from its auction.

It is another object of the present invention to provide a method that allows an auctioneer to determine whether to acquire a commodity in order to auction it. In one aspect of the invention, an auctioneer can solicit participation fees and, if it does not receive a satisfactory amount of participation fees, it can refund them, cancel the auction and elect to not purchase the item that was to be auctioned.

It is another object of the invention to mitigate the auctioneer's risk of loss, but while limiting and pre-identifying the amount that losing auction participants will spend merely to participate.

Finally, it is another object of the present invention to provide a method that is adaptable to most known auction methods, For example, the present participation fee scheme and purpose therefore is applicable the English auction as well as other auction types.

### BRIEF DESCRIPTION OF THE DRAWINGS

FIG. 1 is a flow diagram illustrating the steps of a preferred embodiment of a method for mitigating the financial risk of auctioning a commodity according to the present invention.

### DETAILED DESCRIPTION OF THE PREFERRED EMBODIMENTS

This disclosure, as defined by the claims that follow, relates to a method for mitigating the financial risk of participating in an action as an auctioneer and, relative to conventional penny auction methods, as a purchase participant. As used in this disclosure and the claims, the term “auction” can refer to several different known types of auctions. Furthermore, the current method can be practiced, not only as a means of recouping funds expended, by an auctioneer, to acquire an item for auction, but also as a means of determining whether expending funds to acquire the item is even warranted in the first place (i.e., determining if sufficient funds can be collected by soliciting participation fees).

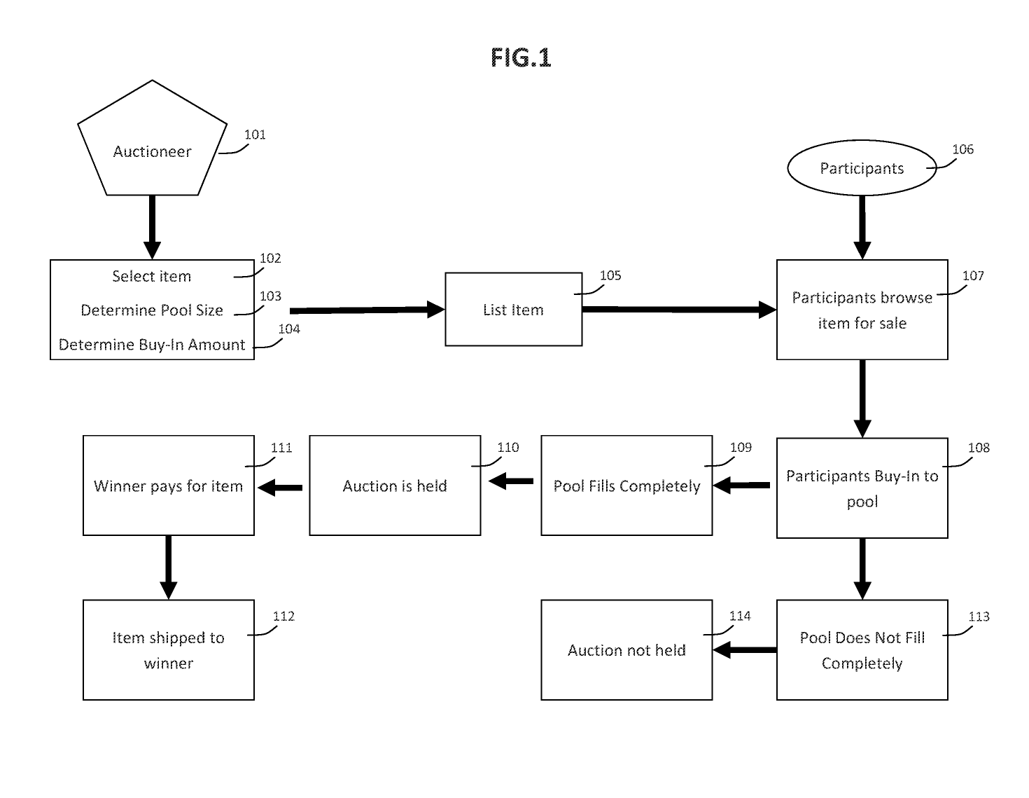

As indicated in FIG. 1, the present method for mitigating the financial risk of conducting an auction involves interactions between two entities: (1) an auctioneer 101 who provides an online auction platform; and (2) prospective auction participants 106 that pay fees in order to participate in an auction and then competitively bid on an item 110 according to the particular auction method employed. The aforementioned term “auction platform” jointly refers to a server (not shown) and a website stored thereon. A communication network (not shown) through which the server and website are accessed by prospective participants' terminals (e.g., personal computers, televisions, PDA's, wireless phones, etc.) will typically be the Internet, but it may be virtually any network through which the server can send/receive data to/from remote terminals, including telephone networks, satellite broadcast networks and cable networks.

In a preferred embodiment, anyone who wishes to participate in an auction for an item is required to “buy-in” to a “bidding pool” by paying a participation fee set by the auctioneer. The buy-in is a fee a prospective participant pays in order to enter the bidding pool and participate in the auction, It is anticipated that the auction would have a limited number of participation slots and that the product of that participation limit and the individual participation fee amount would equal some target amount, or “mitigation amount,” that is in some predetermined proportion to the auctioneer's acquisition cost for the item. For example, if the proportion is to be 50%, then for an auction item that cost the auction host $1,000 to procure, a participation fee of $5.00 might be assessed to the first 100 individual attempting to enter into the auction (raising $500 in total participation fees). In the context of an auction having no minimum bid requirement, this process reduces the auction host's financial risk associated with auctioning each item from the full cost of acquiring the item down to some more palatable amount—from $1,000 down to $500 in this example. However, bidding pool sizes and be infinitely large, especially when a time limit for paying the participation fee is imposed. In such cases, an auctioneer can potentially realize a windfall from participation fees alone. However, it is anticipated that participants will be attracted by the prospect of competing against a finite number of competitors and will prefer limited pool sizes.

In any event, once the period for paying participation fees concludes (either because a desired amount is raised or because a payment deadline is reached), an auction ensues. However, if the desired fee amount is not raised, the auction is postponed.

Finally, although, it is well within the scope of the invention to impose a time limit for paying such participation fees and reaching such a participation limit, a time limit is not essential to the current invention.

It is understood that substitutions and equivalents for and combinations of various elements set forth above may be Obvious to those skilled in the art and may not represent a departure from the spirit of the invention. Therefore, the full scope and definition of the present invention is to be set forth by the claims that follow.

What is claimed is:

1. A method for mitigating the financial risk of auctioning a commodity, using a server in communication with remote terminals via a communication network, by conditioning the auction on the server receiving from remote terminals a predetermined sum of participation fees, the method comprising:
identifying the commodity acquisition cost, wherein the commodity acquisition cost is the cost to acquire the commodity to be sold in the auction, and wherein acquiring the commodity means obtaining the right to sell the commodity through the auction;
displaying, by a host computer via the network, a conditional offer to allow participation in the auction by paying a participation fee;
receiving, at a host computer, participation fee payments sent to it from remote terminals of interested participants; and
auctioning the commodity on the condition that the sum of received participation fee payments is at least equal to a predetermined percentage of the commodity acquisition cost.

2. The method of claim 1, wherein said communications network comprises at least one of the Internet, a telephone network, a satellite broadcast network, and a cable network.

3. The method of claim 1, wherein displaying comprises a host computer transmitting to remote terminals data representing information about said commodity and said participation fee.

4. The method of claim 1, wherein a payment comprises a submission of information that enables its recipient to collect funds from a financial account.

5. The method of claim 1, wherein said predetermined percentage is fifty percent.

6. A method for mitigating the financial risk of auctioning a commodity, using a server in communication with remote terminals via a communication network, by conditioning the auction on the server receiving from remote terminals a predetermined sum of participation fees by a predetermined time, the method comprising:
identifying the commodity acquisition cost, wherein the commodity acquisition cost is the cost to acquire the commodity to be sold in the auction, and wherein acquiring the commodity means obtaining the right to sell the commodity through the auction;
setting a participation limit, wherein the participation limit is the maximum number of auction participants, and wherein the product of the participation fee amount and the participation limit is a mitigation amount;
displaying, by a host computer via the network, a conditional offer to allow participation in the auction by paying a participation fee;
receiving, at a host computer, participation fee payments sent to it from remote terminals of interested participants; and
auctioning the commodity on the condition that the sum of received participation fee payments equals the mitigation amount.

7. The method of claim 6, wherein said communication network comprises at least one of the Internet, a telephone network, a satellite broadcast network, and a cable network.

8. The method of claim 6, wherein displaying comprises a host computer transmitting to remote terminals data representing information about said commodity and said participation fee.

9. The method of claim 6, wherein a payment comprises a submission of information that enables its recipient to collect funds from a financial account.

10. The method of claim 6, wherein said mitigation amount is at least half of said commodity acquisition cost.

11. A method for mitigating the financial risk of auctioning a commodity, using a server in communication with remote terminals via a communication network, by conditioning the auction on the server receiving from remote terminals a predetermined sum of participation fees by a predetermined time, the method comprising:
identifying the commodity acquisition cost, wherein the commodity acquisition cost is the cost to acquire the commodity to be sold in the auction, and wherein acquiring the commodity means obtaining the right to sett the commodity through the auction;
displaying, by a host computer via the network, a conditional offer to allow participation in the auction by paying a participation fee;
receiving, at a host computer, participation fee payments sent to it from remote terminals of interested participants; and
auctioning the commodity on the condition that the sum of received participation fee payments received by a predetermined time is at least equal to a predetermined percentage of the commodity acquisition cost.

12. The method of claim 11, wherein said communication network comprises at least one of:
the Internet, a telephone network, a satellite broadcast network, and a cable network.

13. The method of claim 11, wherein displaying comprises a host computer transmitting to remote terminals data representing information about said commodity and said participation fee.

14. The method of claim 11, wherein a payment comprises a submission of information that enables its recipient to collect funds from a financial account.

15. The method of claim 11, wherein said predetermined percentage is fifty percent.
